(19) United States
(12) Patent Application Publication
(10) Pub. No.: US 2012/0216784 A1
(43) Pub. Date: Aug. 30, 2012

(54) COMBUSTION OF LOW VAPOUR-PRESSURE FUELS IN SPARK IGNITION ENGINES

(75) Inventors: Tyron Utley, Western Australia (AU); Simon Christopher Brewster, Shipston on Stour (GB); Andrew Tilmouth, Western Australia (AU)

(73) Assignee: ORBITAL AUSTRALIA PTY LIMITED, Balcatta, WA (AU)

(21) Appl. No.: 13/380,249

(22) PCT Filed: Jun. 25, 2010
(86) PCT No.: PCT/AU2010/000803

§ 371 Date: May 10, 2012

(30) Foreign Application Priority Data
Jun. 26, 2009 (AU) 2009902987

(51) Int. Cl. F02M 53/02

(52) U.S. Cl. 123/557

(57) ABSTRACT

A method of vaporising fuel in a spark-ignition engine using the supply of heat into the cylinder to wholly or partly vaporise the fuel, the heat being supplied by operation of a spark plug. One or more engine conditions can be sensed, such as engine temperature, coolant temperature, the cumulative amount of fuel supplied, engine speed or the time elapsed since start-up, and the spark plug operated to supply heat in response to such condition(s). The heat can be supplied by operating the spark plug more than once in an engine cycle or by operating the spark plug to form a spark over a time period determined in response to the engine condition. An AC circuit can be used to produce a substantially continuous spark over a defined time period or suitable angular duration. The heat can be supplied by operating the spark plug prior to engine cranking, to generate heat in the cylinder at engine start-up. A method of reducing spark plug fouling is also disclosed. This method operates the spark plug outside the period required for fuel ignition in order to supply additional heat to the spark plug terminals. Heat can be supplied by operating the spark plug more than once in an engine cycle. Heat can be supplied by operating the spark plug so as to form a spark over a time period representing at least 90° of crank angle. An AC circuit can be used to produce a substantially continuous spark over a defined time period or a suitable angular duration. The heat energy supplied by the spark during a single engine cycle can be in the order of 1000 mJ. These methods can be applied to air-assisted direct fuel injection systems.

### FIELD OF THE INVENTION

The present invention relates to the burning of fuels of low vapour pressure in spark ignition engines. This includes the burning of relatively heavy fuels such as kerosene and diesel fuel, and also the burning of lighter fuels such as ethanol and gasoline in low temperature environments. The invention has particular relevance to engine start-up, but may also be applied at other times as will be apparent.

### BACKGROUND TO THE INVENTION

Efficient combustion in a spark ignition engine relies on vaporisation of the fuel within the engine. When operating a spark ignition engine using gasoline as the fuel to be combusted, at temperatures above about −30° C., at least a proportion of the fuel will form a vapour when the fuel is delivered into an engine cylinder. When a spark is generated within the cylinder by a spark plug, this vapour will be combusted. The resultant heat increase will quickly vaporise the remaining fuel within the cylinder, allowing efficient combustion of the delivered fuel. Heat will be retained by the cylinder, meaning that in subsequent engine operating cycles an increasingly greater proportion of the fuel will vaporise when it is delivered into the cylinder.

When other fuels, such as ethanol, are used in cold conditions, an insufficient proportion of the fuel delivered into the cylinder may vaporise. This is particularly problematic during engine start-up under such operating conditions. This problem is not as prevalent with gasoline which is a mixture of hydrocarbons, at least some of which are sufficiently volatile to vaporise at low temperatures. Ethanol, on the other hand, has substantially uniform volatility, and thus a threshold temperature must be reached before a sufficient vapour pressure is reached to enable combustion. This temperature is in the order of 11° C.

Accordingly, in environments where an engine must be started in an ambient temperature less than about 11° C., other methods must be employed to allow the engine to start. Methods employed to date include the use of a separate gasoline fuel supply until the engine cylinder reaches a required temperature, the use of a gasoline/ethanol blend as the primary fuel for combustion and, in some cases, the use of an electrically powered engine heater.

It is desirable to provide an ethanol-powered engine that can start at relatively low temperatures without resorting to these methods.

Similar problems exist where heavier fuels are used in spark ignition engines. Fuels such as kerosene and diesel fuel are also mixtures of hydrocarbons, but without the more volatile components found in gasoline. For this reason, start-up of spark-ignition engines using such heavy fuels in cold environments is subject to similar problems as described in respect of ethanol.

Further problems are also prevalent when heavy fuels are used in spark ignition engines. Even where the engine cylinder is sufficiently warm that adequate vaporisation of the delivered fuel occurs, there may still be heavier fractions of the fuel which do not fully combust. This can lead to significant fouling of the spark plug within an engine operating on heavy fuels. This fouling can be so significant where diesel fuel is being spark-ignited that replacement of the spark plug may be required each five to ten hours of engine operation.

The present invention seeks to provide an engine, and a method of operation, which allows the use of less volatile fuels than gasoline while overcoming at least in part some of the above identified problems.

### SUMMARY OF THE INVENTION

In accordance with a first aspect of the present invention, there is provided a method of vaporising fuel in a spark-ignition engine, the method comprising the supply of heat into the cylinder to at least partially vaporise the fuel, the heat being supplied by operation of a spark plug. This allows use of a heat supply available at engine start-up in order to assist in vaporisation of relatively non-volatile fuels.

Preferably, the method includes the steps of sensing at least one condition of the engine, and operating the spark plug to supply heat in response to the measured condition. The condition may be the engine temperature, the coolant temperature, the cumulative amount of fuel supplied, the engine speed, the time elapsed since start-up, or another suitable measure. This promotes efficiency of operation, as additional heat is only supplied via the spark plug when required for vaporisation of the fuel.

Heat may be supplied by operating the spark plug more than once in an engine cycle, or may be supplied by operating the spark plug so as to form a spark over a time period determined in response to the engine condition. One method of achieving this is to use an AC circuit to produce a substantially continuous spark over a defined time period or suitable angular duration. This time period or angular duration can be based on the amount of heat required to be introduced into the cylinder by activation of the spark plug. The heat energy supplied by such a spark may be in the order of 1000 mJ, in contrast to a normal DC spark producing about 35 mJ. The heat may also be supplied by operating the spark plug prior to engine cranking, to generate heat in the cylinder at engine start-up.

The method may also include the periodic supply of heat into the engine by operation of the spark plug in order to remove or reduce fouling. In this mode of operation, although the engine may be operating under relatively steady state conditions with internal temperatures in the order of 200-250° C., the engine may be controlled so that the spark plug is operated multiple times in a selected engine cycle, or for an extended period in a selected engine cycle, with the selected cycle being chosen based on a regular interval or period of operation.

Although such operation is envisaged to be particularly appropriate to engines operating with heavy fuels such as kerosene and diesel fuel, it may also be usefully applied to engines operating with more volatile fuels such as gasoline, as spark plug fouling can still occur in some conditions. In some situations, the spark may be operated during a period of the engine cycle where combustion is not required, such as during an exhaust stroke or an expansion stroke.

Where extended operation of the spark plug is not required, spark duration may be reduced, such as to the minimum duration for reliable combustion.

Operation of the spark plug during one or more of the above conditions may further help to increase spark plug life. For example, build up of carbon and/or other deposits or fouling on the spark plug may cause tracking through cracking or fracturing of the insulator at the spark plug tip, and possibly complete insulator failure and a short circuit or mis-sparking preventing proper ignition. Maintaining operation of the spark plug aside from normal ignition purposes may alleviate such problems and enhance spark plug life.

Operation of the spark plug during one or more of the above conditions may also help to increase spark plug life through the reduction and/or cleansing of deposits formed on the spark plug ceramic insulator and/or earth electrode(s). Operation of the spark plug prior to engine start and/or extended operation of the spark plug during engine running increases the heat of the spark plug electrodes aiding in burning off any deposits that form on the spark plug. Without such spark plug operation, particularly on engines utilising heavy fuels or oil laden fuels (including as a result of poor piston sealing), excessive deposit build up would occur on and around the spark plug electrodes. Excessive build up of deposits can lead to ‘tracking’ of the ignition spark along the deposits instead of arcing across the spark plug gap. Tracking of the ignition spark normally results in cylinder misfire as the spark is not satisfactory to initiate combustion.

The method of the present invention may also be implemented to alleviate or minimise problems which may arise at start-up due to wetting of spark plugs by the fuel delivered in to the engine cylinders. It will be appreciated that fouling and wetting of spark plugs are different things, though each can cause delayed ignition or prevent efficient ignition for different reasons. Wetting of the spark plug electrode with fuel, such as ethanol, can cause the spark plug to short and hence can prevent a spark from jumping across the spark plug gap. Fouling arises from a build up of carbon deposits on the spark plug, also potentially preventing the spark plug from sparking. In at least one example investigated in relation to the present invention, inspection of the spark plugs on a predominantly ethanol fueled engine showed the spark plugs had been washed clean by the fuel but did not show evidence of fouling.

When starting an engine at cold temperatures with, for example, a high ethanol content, say up to 100% ethanol, the use of long duration sparking has been found to combat spark plug wetting due to the in-volatile nature of 100% ethanol and/or tracking due to the fuel's conductive nature. Spark plug wetting is a recoverable condition such that if the engine warms up, for example to a more normal operating temperature, the fuel typically evaporates leaving a virtually unaltered plug that will facilitate engine starting with no problem.

It has also been realized that spark plug fouling (applicable to heavy fuel or oil laden fuels) may be combated using long duration spark plug operation by generating heat to prevent such fouling.

The invention may be applied with particular advantage to engines employing air-assisted direct fuel injection systems, such as those developed by the applicant. Such systems are well adapted to meet the needs of delivering and atomising heavy fuels for spark ignition applications.

Air-assisted direct fuel injection systems utilise compressed air to deliver a pre-metered amount of fuel through a delivery injector directly to a combustion chamber of an engine. During engine operation, it is necessary to provide a supply of compressed air at the required pressure to effect satisfactory and repeatable fuel delivery events. The provision of sufficient compressed air during engine start-up can however be problematic, as supply from an engine-driven air-compressor is not available immediately upon start-up. Typically, therefore, the engine must complete a number of cycles without fuel before air at the required pressure is available to assist in the injection of fuel.

In one aspect, the present invention proposes activation of the spark plug during these cycles in which no fuel is being injected, in order to supply heat into the cylinder, and to raise the temperature of the spark plug. Alternatively, the spark plug may be operated before cranking of the engine begins.

According to embodiments of the present invention, extended duration sparking of the spark plug(s) during start-up can help to vapourise the fuel on or around the tip of the spark plug.

Another advantage of embodiments of the present invention is to ‘burn off’ deposits from the spark plug tips, such as when used in heavy fuel applications.

Extended duration sparking of the spark plug(s) can advantageously be provided by an alternating current (AC) ignition system, which arrangement has been found not to suffer heating issues prevalent with other ignition systems.

Embodiments of the present invention are particularly efficacious where rich or stoichiometric fuel ratios are employed and the likelihood of spark plug wetting at start-up is increased. However, increased duration sparking of the present invention even in lean fuel ratio applications will increase the probability of initiating combustion.

Embodiments of the present invention may further benefit from the use of ignition systems able to provide low power, long duration sparking, which can include standard spark plugs used in many engine applications. Such ignition systems can provide increased efficiency in burning off deposits or vapourising fuel on the spark plug tip as they provide a more effective heat transfer to the spark plug electrodes. High power sparks, such as those generated by CD ignition systems typically produce a high instantaneous temperature from the short duration spark generated that is quickly dissipated to the surrounding air. A low power, long duration arc according to embodiments of the present invention can provide a similar total energy input whilst being more effective at transferring heat to the spark plug electrodes and hence more efficient at burning off deposits or vapourising fuel.

According to one or more embodiments of the present invention, low power sparking over a relatively long duration helps to heat the spark plug tip(s). This arrangement has been found to be particularly efficacious where standard/ordinary spark plugs are used. The adoption of low power, long duration sparking need not require special or modified spark plugs. Pre-heating of the spark plug electrodes assists in fuel vaporization and/or burning off deposits. Preferably the ignition driver(s) for the spark plug(s) is low power but can operate for extended periods or continuously.

### BRIEF DESCRIPTION OF THE DRAWINGS

It will be convenient to further describe the invention with reference to preferred embodiments of the method of the present invention. Other embodiments are possible, and consequently, the particularity of the following discussion is not to be understood as superseding the generality of the preceding description of the invention. In the drawings:

FIG. 1 shows a plot with representative traces as follows;

1(a) is a representative timing diagram of the spark plug operation in a traditional spark-ignition engine;

1(b) is a representative timing diagram of the spark plug operation in an engine employing an embodiment of the present invention;

1(c) is a representative timing diagram showing cylinder pressure in a typical spark-ignition engine; and

1(d) is a representative diagram showing spark initiation events during spark plug operation in an engine employing a further embodiment of the present invention.

FIG. 2 shows a comparative table of starting times (engine rpm to exceed 700 rpm) for given temperatures incorporating values for an embodiment of the present invention.

FIG. 3 shows a trace of high energy ignition for an embodiment of the present invention.

### DESCRIPTION OF PREFERRED EMBODIMENT

An embodiment of the present invention has been tested on a spark-ignition internal combustion engine employing 100% ethanol fuel during cold start conditions. The testing has been conducted using a spark produced by a device similar to that described in U.S. Pat. No. 7,121,270.

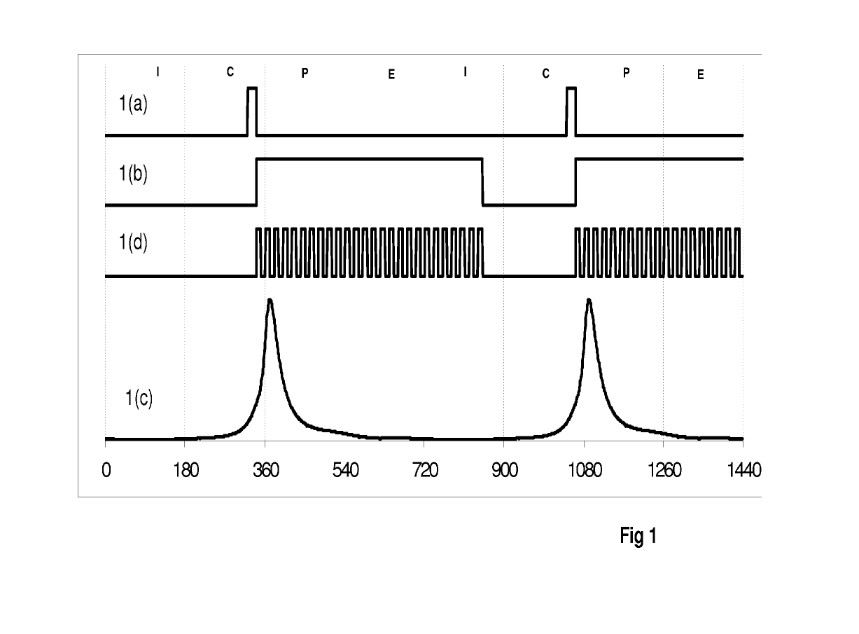

The accompanying figure shows a timing diagram for a four-stroke spark ignition engine. In traditional engine operation, pressure rises in the engine cylinder during a compression stroke. Towards the end of the compression stroke, a spark plug is fired for a defined time period or for a suitable angular duration, as shown in FIG. 1(a). This ignites some of the fuel delivered into the combustion chamber and generates a flame front which subsequently combusts the remaining fuel within the engine cylinder, producing energy which is recovered during the expansion stroke. Exhaust and intake strokes then proceed in the known way to expel combusted gases from the engine cylinder and draw further air into the engine cylinder for a next combustion event.

The implementation of the embodiments of the invention shown in FIGS. 1(b) and 1(d) rely on the fact that neither combustion products nor intake air are able to be combusted absent of some fuel. Operation of the spark plug, either continuously or repeatedly, during the exhaust stroke and the inlet stroke thus do not substantially alter the cylinder pressure trace as shown in FIG. 1(c).

Where such spark plug operation does have a notable effect is in the supply of heat into the engine cylinder. Continuous or repeated spark plug operation (FIGS. 1(b) and 1(d)) significantly raises the temperature of the spark plug terminals. This additional heat generated at and about the spark plug can be used during start-up to help vaporise relatively un-volatile fuels, and can also be used during heavy-fuel engine operation to decrease fouling of the spark plugs.

In the embodiment shown, the spark plug can be operated up until the point that fuel is next injected into the cylinder. Where the fuel is provided through an intake port such as in a standard manifold port injection (MPI) arrangement, it may be necessary to cease operation of the spark plug at the end of the expansion stroke. In such a case, the effect of the additional sparking will be less than for a direct injected engine.

As shown in FIG. 1(b), heat may be supplied by continuous sparking maintained for up to around 540° of crank angle of a standard operating or cylinder cycle of a four stroke engine. it will be appreciated that heat may be supplied by operating the spark plug so as to spark over a time period representing at least 90° of crank angle. Sparking may be maintained in a range between 5° and 540° of crank angle from commencement of marking, which may commence prior to engine starting. In at least one alternative embodiment, sparking may commence before the engine is cranked and may continue whilst the engine commences cranking. For example, sparking may commence before the engine is cranked, and then at 0° (not 0° TDC, bit 0° with respect to the commencement of cranking) the engine commences cranking and sparking continues. Sparking may be formed by a continuous or intermittent spark over the period of sparking time.

Where the fuel injector is an air-assisted injector, it may be necessary to crank the engine through several cycles to build sufficient air pressure in the injector rail before satisfactory fuel delivery into the engine cylinder can commence at engine start-up. In such a case, the spark plug can theoretically be operated continuously during these cycles, in order to raise the plug terminal temperatures and to provide heat into the cylinder. In such an application, the limit to the amount of sparking is related to the available electrical supply.

It will be appreciated that a single engine may be arranged to operate in each of the modes described above: that is, to continuously or repeatedly spark during a pre-ignition pressure build-up phase to help vaporise fuel (which may otherwise wet the spark plug(s)), to employ long or repeated sparks during an engine warm-up phase, and to periodically employ long or repeated sparking during engine operation to prevent spark plug fouling.

The choice of one or more of these modes may depend on the particular fuel being used, and the prevailing engine operating conditions.

Where this technique is being used during engine warm-up, it may also be appropriate to control the length of the spark event, the number of sparks, or the frequency of unusual sparking events as a function of measured engine conditions. Suitable conditions that could be used as controls include engine temperature, coolant temperature, the cumulative amount of fuel supplied, the engine speed, and the time elapsed since start-up. It will be appreciated that this is not an exhaustive list, and other suitable measures of engine condition may be employed.

As alluded to hereinbefore, in certain applications, it may also be applicable or beneficial for the spark plug to be operated before cranking of the engine begins in order to provide some initial heat in to an engine cylinder. This may be done for example for a predetermined time or for a preset number of cycles at a point when a vehicle is keyed-on prior to engine starting and may be based one or more factors, such as for example, prevailing engine or ambient temperature conditions

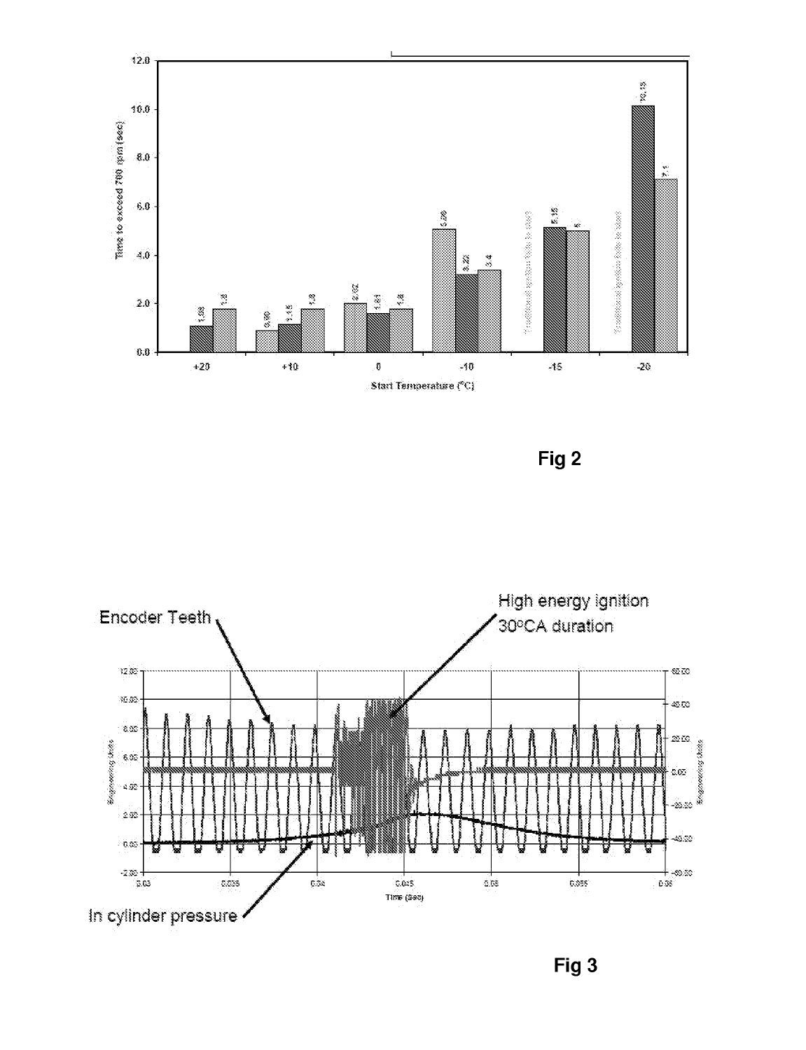

FIG. 2 depicts a bar chart showing a comparison of start times for

1). a standard ethanol fueled direct injection engine,

2). a engine having a long duration sparking ignition system according to an embodiment of the present invention; and

3). an industry standard diesel fueled (compression ignition) engine.

The data depicted in FIG. 2 is also listed in the following table for ease of reference.

| | Time to exceed 700 rpm (sec) upon engine start | | |
|---|---|---|---|
| Start | | | Industry |
| Temperature | Standard DI4 | Enhanced DI | Standard |
| ° C. | Ethanol Engine | Ethanol Engine | Diesel Engine |
| +20 | Less than 1.0 | 1.08 | 1.8 |
| +10 | 0.90 | 1.15 | 1.8 |
| 0 | 2.02 | 1.61 | 1.8 |
| −10 | 5.06 | 3.22 | 3.4 |
| −15 | Fails to start | 5.15 | 5.0 |
| −20 | Fails to start | 10.15 | 7.1 |

The above table and FIG. 2 reveal a notably shortened time for an ethanol fueled engine operating according to an embodiment of the present invention to reach 700 rpm at start-up, especially from 0° C. and below.

It will be appreciated that the extended duration sparking (long duration ignition) can be beneficial in providing reduced start times at cold temperatures, particularly on engines operating with high proportion ethanol fuels.

FIG. 3 shows an example were extended ignition is maintained over 30 degrees of crank angle during operation of an engine. The trace 10 relates to the sensing of encoder teeth for the engine, trace 12 relates to a high energy ignition signal over 30° C.A, and trace 14 relates to the in-cylinder pressure for the engine. In this example, the method includes starting the ignition pulse at a beneficial angle wrt the end of the air injection pulse in an air-assisted fuel injection system (i.e. which delivers the fuel to the engine cylinder) and then continuing to fire the ignition for a defined duration which may extend across TDC firing and into the next cycle. This long duration could be discontinued or ramped down on detection of engine firing and an increase in engine speed. Ignition duration could also be reduced in duration as the engine temperature at start-up begins to increase.

Modifications and variations as would be apparent to a skilled addressee are deemed to be within the scope of the present invention.

1. A method of vaporising fuel of lower volatility than gasoline in a spark-ignition engine, the method comprising:
sensing at least one condition of the engine; and
supplying heat into a combustion chamber of a cylinder of the engine to at least partially vaporise said fuel of lower volatility than gasoline, the heat being supplied by operation of a standard spark plug in response to the sensed at least one condition.

2. The method of claim 1, wherein the condition is at least one of engine temperature, coolant temperature, the cumulative amount of fuel supplied, engine speed, or the time elapsed since start-up.

3. The method of claim 1, wherein the heat is supplied by operating the spark plug more than once in an engine cycle.

4. The method of claim 1, wherein the heat is supplied by operating the spark plug to form a spark over a time period determined in response to the engine condition.

5. The method of claim 4, wherein an alternating current (AC) circuit is used to produce a substantially continuous spark over a defined time period or suitable angular duration.

6. The method of claim 1, wherein the heat supplied by the spark plug to the cylinder during a single engine cycle is approximately 1000 mJ.

7. The method of vaporising fuel as claimed in claim 1, wherein the heat is supplied by operating the spark plug prior to engine cranking, to generate the heat in the cylinder at engine start-up.

8. A method of reducing spark plug fouling, the method comprising operating the spark plug outside the period required for fuel ignition in order to supply additional heat to the spark plug terminals.

9. The method of claim 8 wherein the heat is supplied by operating the spark plug more than once in an engine cycle.

10. The method of claim 8, wherein the heat is supplied by operating the spark plug to form a spark over a time period representing at least 90° of crank angle.

11. The method of claim 10, wherein an alternating current (AC) circuit is used to produce a substantially continuous spark over a defined time period or a suitable angular duration.

12. The method of claim 8, wherein the heat supplied to the spark during a single engine cycle is approximately 1000 mJ.

13. The method of claim 8, wherein the method is applied to an air-assisted direct fuel injection systems.

14. The method of claim 1, wherein the method is applied to an air-assisted direct fuel injection system.
